(19) United States
(12) Patent Application Publication
(10) Pub. No.: US 2014/0324633 A1
(43) Pub. Date: Oct. 30, 2014

(54) FREIGHT SERVICES MARKETPLACE SYSTEM AND METHODS

(71) Applicant: FREIGHTOPOLIS INC., Montreal (CA)

(72) Inventors: Jacob Pollak, Montreal (CA); Chaim Stern, Montreal (CA); Eric Beckwitt, Montreal (CA)

(73) Assignee: FREIGHTOPOLIS INC., Montreal (CA)

(21) Appl. No.: 14/018,536

(22) Filed: Sep. 5, 2013

Related U.S. Application Data
(60) Provisional application No. 61/817,392, filed on Apr. 30, 2013.

(51) Int. Cl. G06Q 10/08; G06Q 30/06

(52) U.S. Cl. CPC G06Q 10/083; G06Q 30/0627
USPC 705/26.63

(57) ABSTRACT

A computer system and associated methods for implementing an online freight services marketplace. Freight service offerings posted to the marketplace by carriers are matched to freight service requests from shippers. Compound service offerings are formed from freight service offerings having service parameters (lane, space, transit time, availability, price, and status) that accommodate load parameters (origin, destination, size, and weight) of the freight service request. Compound service offerings selected by the shipper are provisioned and reserved for subsequent dispatch. Role-based access controls within the marketplace restrict visibility of confidential information, such as carrier pricing and shipper identity. Automatic freight transaction facilitation includes shipper payment processing and shipping document generation. Status tracking capability may be augmented with alert messaging and/or in-transit re-planning to minimize the impact of common issues that threaten to defeat a shipment in progress.

### RELATED APPLICATIONS

This application claims the benefit Under 35 U.S.C. §119(e) of U.S. Provisional Patent Application Ser. No. 61/817,392 filed on Apr. 30, 2013 and titled System For Providing Freight Data, Vehicle Availability And Quotes, the entire contents of which are incorporated herein by reference.

### FIELD OF THE INVENTION

The present invention relates to the field of freight transport and, more specifically, to facilitation of freight transport transactions using a communications network, and associated systems and methods.

### BACKGROUND OF THE INVENTION

The global freight transport industry is large and complex, comprising hundreds of thousands of transport companies serving millions of shipping customers each year. Freight service transactions typically involve actors in three basic roles: carriers, shippers, and brokers. Carriers provide transport assets and associated support, and the business model of each carrier may be characterized by unique service routes, availability schedules, and offering prices. Freight to be moved is specified by shippers, each of whom may be an owner of the freight or an agent operating in support of another freight owner. A freight broker provides the fee-based service of helping a shipper identify a carrier capable of satisfying the freight service requirements of the shipper.

The freight broker adds value to a particular freight service transaction through his knowledge of the assets, routes, availabilities, and prices of local carriers. Currently, the broker draws most of this information about carrier capability either from load matching software or from the broker's experience-based insight into which carrier is likely service candidate in a given set of circumstances. No existing matching software allows freight brokers or shippers to know if the carriers' equipment is guaranteed available. Instead, current matching software can, at best, identify a given carrier asset as “probably available,” and with no accompanying indication of the space, weight, pricing, and transit time characteristics of the asset of interest. As the shipping industry experiences explosive growth, freight service transaction processes that are dependent on industry knowledge and human intervention are increasingly becoming unmanageable.

Various approaches exist in the freight industry for allowing shippers to book freight services with carriers with less reliance on broker knowledge and manual processes. For example, Freightquote.com® and FreightCenter.com® are two of the best known online freight quoting systems in North America. But these and similar online systems work only with carriers that have price data that are stored in existing databases and/or are available via automated programming interface (API). This design limitation in these online systems limits their utility to only with largest carriers (comprising only about 17 common carriers out of approximately 200,000 carrier companies). No quoting software used to match carriers to shippers gives access to smaller carriers who do not employ large infrastructures and databases to post their prices, availabilities, and transit times (PATT) online.

Contributing to the proliferation of proprietary quoting systems and to the exclusive nature of commercially available quoting systems is the fact that carriers carefully guard their prices for competitive reasons. Carriers typically refuse to post pricing information in any system where that information potentially could be viewed by competitors. Instead, carriers often choose to maintain stovepiped systems that may automate freight service booking and shipment status tracking for a particular carrier, but that do not support direct communication between multiple carriers and/or between carriers and shippers.

Furthermore, the lack of integration between carrier-specific systems leads to manual labor and call time involving the actors involved in a typical freight transaction. Current matching software typically burdens carriers, brokers, and shippers to repeatedly telephone and e-mail each other to sort out service information and to book the loads. Similarly, freight brokers and/or shippers who make use of their own databases of carriers to keep abreast of pricing, availability, and transit times still find booking of loads to be very time consuming due to the amount of paperwork that must change hands manually either by fax or by email. Such manual processes are unreliable because costly mistakes often happen when human intervention is built into the confirmation loop.

The freight transport industry is experiencing advancements in automated generation of shipping quotes. Some of these techniques may be applicable to certain aspects of facilitating freight transport transactions.

U.S. Published Patent Application No. 2011/0246384 by Bennett et al. discloses a solution for online, multi-parcel, multi-carrier, multi-service enterprise parcel shipping management. However, the Bennett application does not disclose freight handling with specificity. Also, Bennett is directed to traditional shipment of packages by a single retail carrier (e.g., UPS®, FedEx®), rather than engagement of multiple carriers in collaboration to deliver a single freight shipment service within a shipper's cost and schedule requirements.

U.S. Published Patent Application No. 2012/0036072 by Riggs et al. discloses a fully-integrated logistics system operated by a third party intermediary for transport of goods from multiple different shippers by multiple different carriers. This networked logistics system operates across all modes of transport (i.e., truck, rail, containership, bulk tanker, and air). However, the Riggs solution presumes human-in-the-loop (that is, third party intermediary) facilitation of negotiations between the shipper and the carriers/logistics suppliers.

U.S. Published Patent Application No. 2005/0021346 by Nadan et al. discloses a solution that aggregates shipping demand and carrier capacity by treating both shipper loads and carrier assets as fungible transportation instruments (e.g., in fulfilling a freight service obligation, one shipment may be substituted for another and/or one truck may be substituted for another). However, the Nadan solution is not fully automated in that it relies on human staff members to manage operational problems that routinely surface between pickup and delivery. Also, the Nadan disclosure limits the minimal unit of carrier asset space to be equal to ¼ of a truck.

U.S. Published Patent Application No. 2003/0200111 by Damji discloses an automated process for determining the optimal method and cost of packaging and shipping goods of given order within a required timeframe. However, the Damji solution is limited to the problem of accurately quoting shipping costs prior to a shipper and a carrier(s) consummating a freight service transaction. The Damji disclosure is silent on managing operational problems that may surface between pickup and delivery.

U.S. Published Patent Application No. 2001/0047284 by Blalock et al. discloses a method and system for negotiation of transportation contracts between shippers and carriers, as implemented over a computer network. A carrier may view a request for proposal (RFQ) posted by a seller, and may identify the lanes the carrier would like to bid on. However, this auction-style bidding system does not disclose a marketplace of predefined freight service offerings offered by multiple carriers that a shipper may search for a requirements match.

There exists a need for a computerized product and process for an online marketplace for real-time reservation of space available on the transport assets of freight carriers. More specifically, a need exists for a highly secure, standardized, central repository that shippers may query for real-time price, availability, and transit times. Also, a need exists for automated communication between shippers and freight carriers without the need for human intervention during the quoting, booking, pickup, transportation, and delivery phases of the freight shipment process. Additionally, a need exists for automation of the time consuming process of preparing bills of lading, custom documents, and invoices. These, and other features of a freight services marketplace are not present in the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are directed to a system and methods for implementing a freight services marketplace.

The present invention may be configured to allow freight carriers to post their shipping inventories for sale online for selection by freight shippers. The present invention also may seamlessly provide a single quote to a shipper for a combination of freight offerings provided by multiple carriers. The present invention also may coordinate the passing of a load between multiple carriers, as necessary, to achieve the delivery of the load at a price and a transit time that are acceptable to the shipper. The present invention may allow shippers to query only those freight service offerings for which the advertised shipping asset is available, and to advantageously book freight services online.

The present invention may be configured to advantageously allow freight carriers that have no existing digital price data to quickly and efficiently summarize their complex routes and to store those data in a centralized, secure location that is searchable by shippers. The present invention may service not only large common carriers but also small regional freight companies, thereby advantageously providing these small companies the ability to compete to service specific lanes. The present invention also may be configured to advantageously limit access to prices only to verified shippers, and to prevent carriers from viewing the prices and other confidential business information of competing carriers.

The present invention also may be configured to automatically generate, save, and transmit Bills of Lading and common industry-specific shipping documents required to provision a freight service. The present invention also may be configured to automatically transmit status alert updates to carriers and/or shippers while a shipment is in transit. The present invention also may be configured to alert shippers and/or carriers of common transit problems as they arise. The present invention also may be configured to advantageously handle common transit issues automatically without requiring manual intervention from carriers and/or shippers. More specifically, the present invention may be configured to transfer a load from one carrier to another in response to a transit issue that threatens to defeat a shipment in progress.

The freight services marketplace according to embodiments of the present invention may be configured as a computer program product that may include a website portal that may be accessible from a communications network and that may be in data communication with a data store. The computer program product may implement a method of facilitating freight transactions that may include the steps of receiving freight service offerings from any number of carriers, receiving a freight service request from a shipper, and combining more than one of the freight service offerings to generate a compound service offering. The method of facilitating freight transactions may further include the steps of receiving a compound service offering selection from the shipper, reserving the selected compound service offering, and dispatching the selected compound service offering to satisfy the freight service request.

Each of the freight service offerings may be characterized by service parameters that may include a lane, a space, a price, an availability, a transit time, and a status. The freight service request may be characterized by load parameters that may include an origin, a destination, a size, and a weight. The compound service offering may be characterized by service parameters that accommodate the load parameters of the freight service request.

To facilitate receipt of freight service offerings from carriers, access the website portal may be controlled by processing a carrier registration for each carrier, verifying the carrier registration upon the carrier accessing the website portal, and restricting each carrier from accessing the confidential carrier information of other carriers, including the price of competing freight service offerings. To facilitate receipt of the freight service request from the shipper, access the website portal may be controlled by processing a shipper registration for the shipper, verifying the shipper registration upon the shipper accessing the website portal, and restricting the carriers from accessing confidential shipper information, including the name of the shipper.

Generating the compound service offering may include the steps of identifying a combination of the lanes of the freight service offerings that accommodates the origin and the destination of the freight service request, identifying space in each of the freight service offerings that accommodates the size and the weight of the freight service request, and identifying that each of the freight service offerings is available for reservation. Compound service offering generation may also include the steps of combining the transit times of the freight service offerings included in the compound service offering, and summing the prices of the freight service offerings included in the compound service offering.

To facilitate reservation of the selected compound service offering, the method may include the step of receiving an escrow payment from the shipper. Escrow payment may be in the form of a system credit and/or a credit card payment. Upon receipt of the selected compound service offering, the reservation step may include setting indicators signifying that each of the included freight service offerings is no longer available.

The method of dispatching the selected compound service offering may include the steps of monitoring the status of each of the freight service offerings, and sending an alert message to the shipper and/or the carrier to communicate the status of each monitored service offering. Identification of a monitored service offering having at least one service parameter that does not accommodate the load parameters of the freight service request may trigger the steps of generating an alternative compound service offering to replace the monitored service, reserving the alternative compound service offering, and dispatching the alternative compound service offering. The method of facilitating freight transactions may further include the steps of identifying delivery completion, and remitting a service payment to the carrier from which the monitored service was received.

### BRIEF DESCRIPTION OF THE DRAWINGS

FIG. 1 is a schematic block diagram of a freight services marketplace system according to an embodiment of the present invention.

FIG. 2A is a diagram illustrating exemplary data structures of the freight services marketplace system depicted in FIG. 1.

FIG. 2B is a diagram illustrating exemplary fields of the freight service offering data structures depicted in FIG. 2A.

FIG. 3A is a flow chart illustrating a method of user account creation as used in connection with a freight services marketplace system according to an embodiment of the present invention.

FIG. 3B is a diagram illustrating exemplary carrier account access permissions as used in connection with a freight services marketplace system according to an embodiment of the present invention.

FIG. 4 is a flow chart illustrating a method of freight service offering data entry as used in connection with a freight services marketplace system according to an embodiment of the present invention.

FIG. 5 is a flow chart illustrating a method of managing posting of freight service offerings as used in connection with a freight services marketplace system according to an embodiment of the present invention.

FIG. 6A is a diagram illustrating an exemplary system interface for freight service offering data entry as used in connection with a freight services marketplace system according to an embodiment of the present invention.

FIG. 6B is a diagram illustrating an exemplary system interface for freight service offering data entry as used in connection with a freight services marketplace system according to an embodiment of the present invention.

FIG. 7 is a flow chart illustrating a method of freight service request data entry as used in connection with a freight services marketplace system according to an embodiment of the present invention.

FIG. 8A is a diagram illustrating an exemplary system interface for freight service request data entry as used in connection with a freight services marketplace system according to an embodiment of the present invention.

FIG. 8B is a diagram illustrating an exemplary system interface for freight service request data entry as used in connection with a freight services marketplace system according to an embodiment of the present invention.

FIG. 9 is a flow chart illustrating a method of freight service booking as used in connection with a freight services marketplace system according to an embodiment of the present invention.

FIG. 10 is a diagram illustrating an exemplary system interface for freight service booking data entry as used in connection with a freight services marketplace system according to an embodiment of the present invention.

FIG. 11 is a flow chart illustrating a method of freight service dispatch management as used in connection with a freight services marketplace system according to an embodiment of the present invention.

FIG. 12 is a diagram illustrating an exemplary system interface for freight service dispatch management as used in connection with a freight services marketplace system according to an embodiment of the present invention.

FIG. 13 is a flow chart illustrating a method in-transit freight service re-planning as used in connection with a freight services marketplace system according to an embodiment of the present invention.

FIG. 14 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention. Like numbers refer to like elements throughout.

The terms “generally” and “substantially” may be used throughout the application. “Generally” may be understood to mean approximately, about, or otherwise similar in content or value. “Substantially” may be understood to mean mostly, more than not, or approximately greater than half. The meanings of these terms must be interpreted in light of the context in which they are used, with additional meanings being potentially discernible therefrom.

Throughout this disclosure, the present invention may be referred to as a freight services marketplace system, a quoting system, a scheduling system, a freight system, a freight service system, a computer program product, a computer program, a product, a system, a device, and a method. Furthermore, the present invention may be referred to as relating to freight transport using trucks. Those skilled in the art will appreciate that this terminology does not affect the scope of the invention. For instance, the present invention may just as easily relate to freight assets used to transport by road, rail, air, and/or water lanes.

Other industry-specific terms that may be pertinent to this disclosure include the following:

Skid—a flat base on which goods can be stacked for easy handling

Palletized—freight loaded on skids

Floor Load—freight loaded without skids on the floor of a trailer

Full Truck Load (FTL)—per-asset pricing (based on full capacity)

Less Than Load (LTL)—per-skid pricing (based on subset of capacity)

Both—shipper requirements determine FTL or LTL

Unlimited LTL—per-skid pricing, with no limit on the total number of skids and maximum weight

Example systems and methods for a freight services marketplace are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

### System Architecture

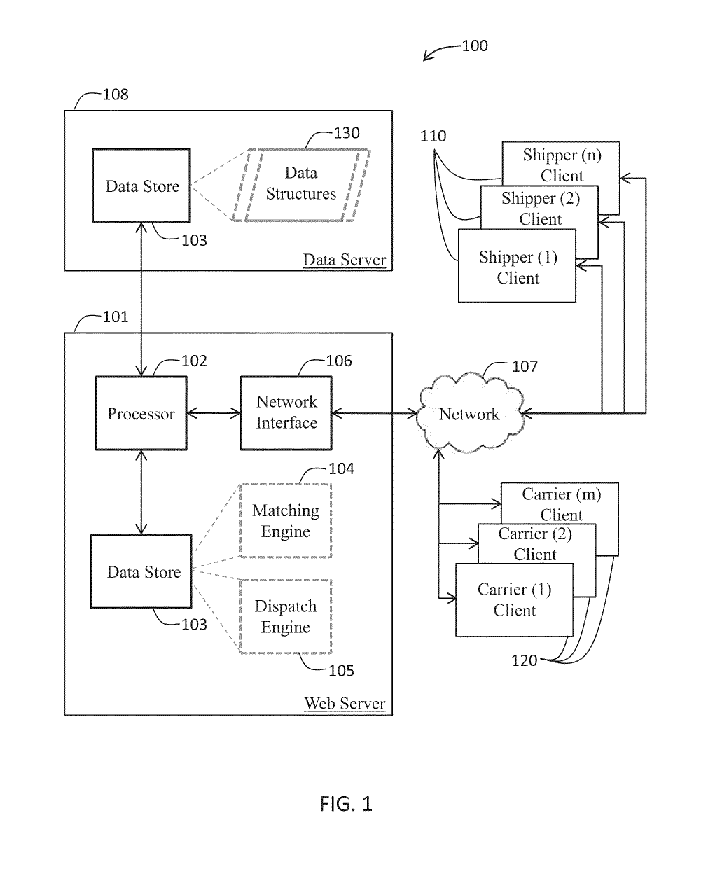

Referring now to FIGS. 1 through 14, a freight services marketplace system 100 configured to facilitate freight services transactions and to track freight service delivery will now be discussed.

Referring more specifically to FIG. 1, the freight services marketplace system 100, according to an embodiment of the present invention, may include a web server 101, which may be coupled to at least one shipper client 110 and at least one carrier client 120. Each shipper client 110 and each carrier client 120 may be coupled to the web server 101 using a wide area network 107 such as the Internet. For example, and without limitation, the web server 101, shipper clients 110, and carrier clients 120 also may have access to various third-party freight service information sources via the Internet 107. Third-party freight service information sources, for example, and without limitation, may include commercial-off-the-shelf applications (for example, and without limitation, routing, mileage, and mapping software) and proprietary applications (for example, and without limitation, dispatching software maintained internally by a given carrier).

Shipper clients 110 and carrier clients 120 each may comprise a web browser and a communication application. “Web browser” as used herein includes, but is not limited to, any application software or program (including mobile applications) designed to enable users to access, retrieve, and view documents and other digital content over a wide network such as the Internet. “Communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders and other forms of electronic communication. Those skilled in the art will recognize that other forms of communication known in the art are within the spirit and scope of the present invention.

Users of a shipper client 110 may be prospective shipping service consumers. For example, and without limitation, consumers who may make use of the freight service marketplace system 100 through their shipper clients 110 may include any company or individual purchasing space on a transport asset, as well as associated support and handling services, for purposes of shipping freight. Also for example and without limitation, consumers may include brokers and/or any individuals desiring to book freight shipment space and support services on behalf of others. Users of a carrier client 120 may include providers of any type of shipping asset (e.g., a truck) that may be hired out or conscripted for any private or public purpose (freight shipping, humanitarian evacuation, and/or emergency services).

Continuing to refer to FIG. 1, the web server 101 may comprise a processor 102 that may accept and execute computerized instructions, and also a data store 103 which may store data and instructions used by the processor 102. More specifically, the processor 102 may be configured to receive input from some number of shipper clients 110, carrier clients 120, and third-party freight service information sources (not shown) and to direct that input to the data store 103 for storage and subsequent retrieval. For example, and without limitation, the processor 102 may be in data communication with external computing resources 110, 120 through a direct connection and/or through a network connection 107 facilitated by a network interface 106. Also for example, and without limitation, the data store 103 may comprise multiple data stores hosted either locally on the web server 101, and/or remotely on a data server 108.

Matching engine instructions 104 may be stored in data store 103 and retrieved by the processor 102 for execution. The matching engine 104 may be configured to advantageously automate the capture of a freight service request from a shipper, the entry of freight service offerings from one or more carriers, and the presentation of combined freight service quotes for selection by the shipper. Dispatch engine instructions 105 also may be stored in data store 103 and retrieved by the processor 102 for execution. The dispatch engine 104 may advantageously automate transaction processing, including notification of quote acceptance, shipper payment processing, and carrier service rating.

Those skilled in the art will appreciate, however, that the present invention contemplates the use of computer instructions that may perform any or all of the operations involved in delivering freight shipping services, including capacity management, price quotation, reservation handling, service delivery tracking, payment processing, and issue resolution. The disclosure of computer instructions that include matching engine instructions and dispatch engine instructions is not meant to be limiting in any way. Those skilled in the art will readily appreciate that stored computer instructions may be configured in any way while still accomplishing the many goals, features and advantages according to the present invention.

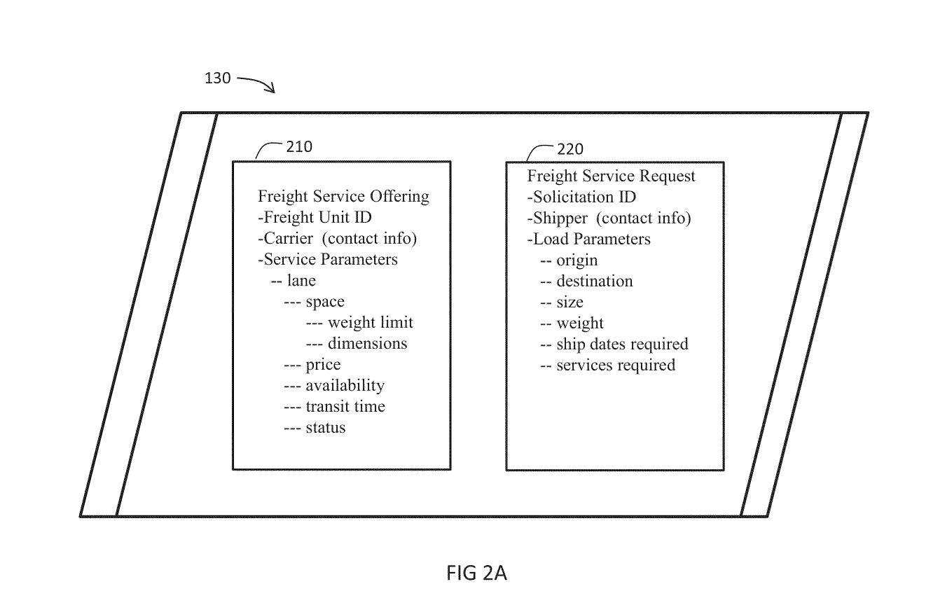

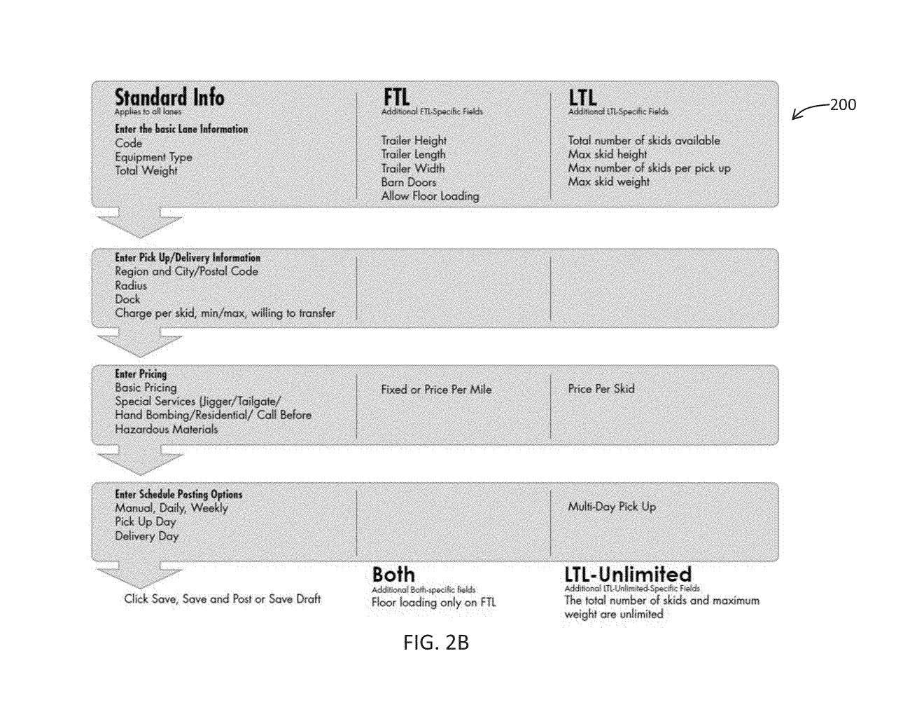

Continuing to refer to FIG. 1, and referring additionally to FIG. 2A, the processor 102 on the web server 101 may write to the data store 103 on the data server 108 carrier-specified information about the availability of freight service offerings, and may retrieve from the data store 103 that information that is pertinent to requirements in a shipper-specified freight service request. Such information may be stored in one or more data structures 130. For example, and without limitation, the matching engine 104 may obtain from the data structure 130 freight service offering information 210 regarding shipping assets and corresponding carriers. Although the data structure 130 shown illustrates information that may be written to and/or retrieved from the data store 103 on the data server 108, employment of networking may permit the freight services marketplace system 100 to retrieve information about freight services from third-party information sources, thereby enhancing the timeliness and completeness of data used by the system.

The illustrated embodiment of freight service data structures 130 shows example data objects 220 that may be pertinent to satisfying the freight service requirements of a prospective shipper. Although the embodiment of the invention discussed herein describes the data storage and retrieval functionality performed by the matching engine 104 and/or the dispatch engine 105, those skilled in the art will readily appreciate that stored computer instructions and data objects may be configured in any way while still accomplishing the many goals, features and advantages according to the present invention.

Continuing to refer to FIG. 2A, the data structure for a freight service offering 210 will now be discussed. A freight asset may be defined as any shipping service unit that may be marketed individually by a carrier. Asset information may comprise a unique identifier (e.g., freight code). Information regarding the carrier providing the asset also may be included in the asset data structure 210. For example, and without limitation, carrier contact information may include the name of the carrier, an email address, a telephone number, a mailing address, and/or any other type of communication address.

For purposes of definition, the fundamental record defining the inventory of a shipper is a lane. This individually billable unit may be characterized by a set of service parameters. More specifically, a freight service offering data structure 210 may comprise a set of service parameters which may include characteristics such as lane, space, price, availability, transit time, and status. For example, and without limitation, each portion of floor or rack space present on a freight asset that may be offered individually for lease may be characterized as a lane. The freight service offering data structure 210 may comprise information regarding the configuration of the space, such as physical dimensions (e.g., length, width, and height) and weight limitations. The transit time for the lane may comprise information about the scheduled movement of the freight asset from one location to another. For example, and without limitation, location may be expressed in terms of a loading facility, a city, a region, or a range (e.g., miles or travel time). Also for example, and without limitation, the scheduled movement of the asset may be expressed as a day of the week for freight pickup and a day of the week for freight delivery. Calculation of transit time as a function of pickup and delivery days of the week, rather than as absolute days travel time, may remove ambiguity regarding the number of days in the future a particular load may be delivered.

Each lane also may be characterized by its offering price. In one embodiment, the web server 101 may receive information on pricing of freight service offering from the carrier that owns the associated asset, and may write that information to the freight service offering data structure 210 on the data store 103. In another embodiment, the matching engine 104 may obtain from freight service offering data structure 210 information regarding the historical price charged by a particular carrier for services like those requested by the shipper. In yet another example, discounting factors may also be included in the pricing criteria stored in the freight service offering data structure 210. Each lane also may be characterized by its projected availability on a given date, and its in-transit status at any given moment. For example, and without limitation, FIG. 2B illustrates one embodiment of the set of service parameters that may be populated for a freight service offering 210.

Continuing to refer to FIG. 2A, the data structure for a freight service request 220 will now be discussed. The freight service request may specify shipper requirements for freight shipment. For example, and without limitation, the freight service request may characterize the needs of the shipper to move a load from one location to another. Also for example, and without limitation, the freight service request may specify more than one leg as included in the required service. Request information may comprise a unique identifier (e.g., solicitation ID). Information regarding the shipper making the request also may be included in the request data structure 220. For example, and without limitation, shipper contact information may include the name of the shipper, an email address, a telephone number, a mailing address, and/or any other type of communication address. The freight service request data structure 220 may list the desired origin and destination locations, the size and weight of the load. The freight service request 220 also may include the required dates of shipment, any associated services such as load handling and transfers, and a deadline for receiving reservation confirmations from prospective freight carriers.

Those skilled in the art will appreciate, however, that the present invention contemplates the use of data structures that may store information supporting any or all of the operations involved in delivering freight shipping services, including capacity management, price quotation, reservation handling, service delivery tracking, payment processing, and issue resolution. The disclosure of data structures that include asset characteristics and pricing criteria is not meant to be limiting in any way. Those skilled in the art will readily appreciate that data structures may be configured in any way while still accomplishing the many goals, features and advantages according to the present invention.

### Carrier Data Entry

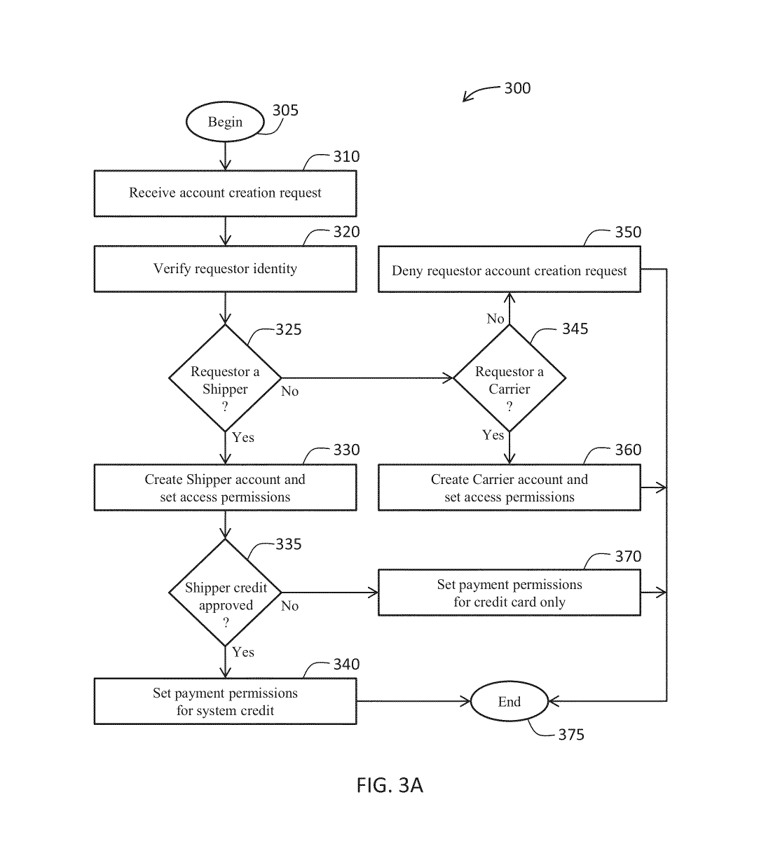

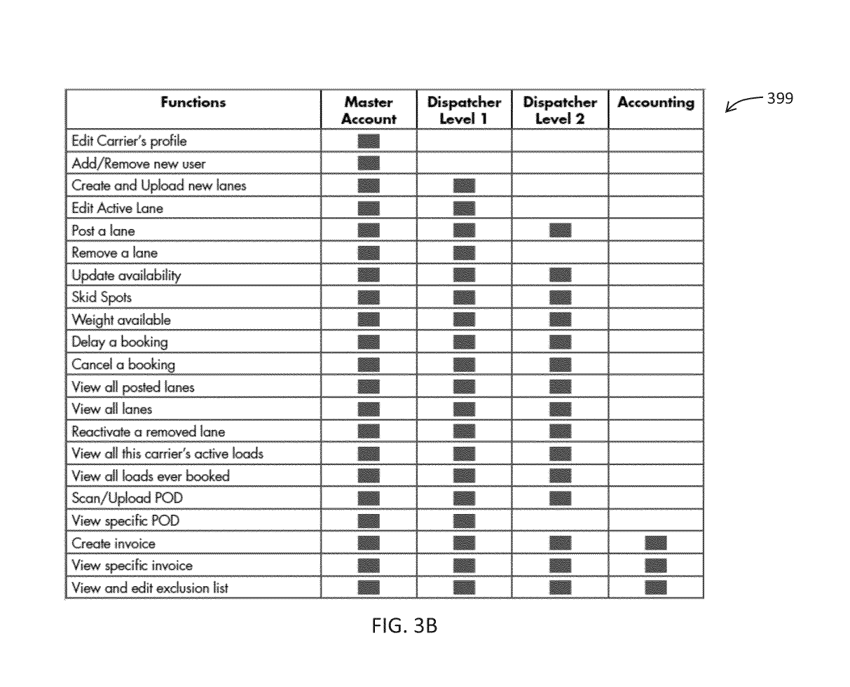

Referring now to FIGS. 3A, 4, 5, 6A, and 6B, and continuing to refer to FIGS. 1, 2A, and 2B, a method aspect for entering carrier data into the freight services marketplace system 100, according to an embodiment of the present invention, will now be discussed. In the methods illustrated herein, the carrier may use the carrier client 110 to interact with the web server 101. The following illustrative embodiment is included to provide clarity for certain operational methods that may be included within the scope of the present invention. A person of skill in the art will appreciate additional databases and operations that may be included within the freight services marketplace system 100 of the present invention, which are intended to be included herein and without limitation.

Referring now to FIG. 3A, and continuing to refer to FIGS. 1, 2A, and 2B, a method aspect 300 for creating a user account for the carrier in the freight services marketplace system 100 will now be discussed in detail. The carrier may use an account creation interface on the carrier client 120 to request a carrier account and to submit self-identifying information through a network 107 to the web server's network interface 106. For example and without limitation, the account creation interface may be in the form of a web-based application accessible through a web browser on the carrier client 120. The processor 102 may route the carrier account creation information to the data store 103. As illustrated in FIG. 1, the data store 103 may be located on the web server 101 and/or on the data server 108.

From the beginning at Block 305, the system 100 may receive from the carrier an account creation request (Block 310). An appropriately-privileged administrator of account requests may use this information received by the system 100 to verify the role of the requestor in the shipping industry. For example, and without limitation, if the requestor cannot be identified as either a shipper (Block 325) or a carrier (Block 345), then the account creation request may be denied (Block 350) and the process ends (Block 375).

If the account administrator can identify the requestor as a carrier (Block 345), then the system 100 may allow creation of the carrier account and may set access permissions to limit the account holder to access information on the system 100 on a need-to-know basis (Block 360). For example, and without limitation, access controls may permit any pricing data stored by a carrier to be viewable by prospective customers who are shippers, but not by another carrier account holder. Such access controls may advantageously allow multiple carriers to sell their respective freight service offerings using the freight services marketplace system 100 without exposing confidential business information, such as pricing, to competitors. Also for example, and without limitation, role based access controls may privilege carrier account holders to invoke only those functions within the freight services marketplace system 100 for which the account of the user is approved (example roles and associated privileges are illustrated in FIG. 3B).

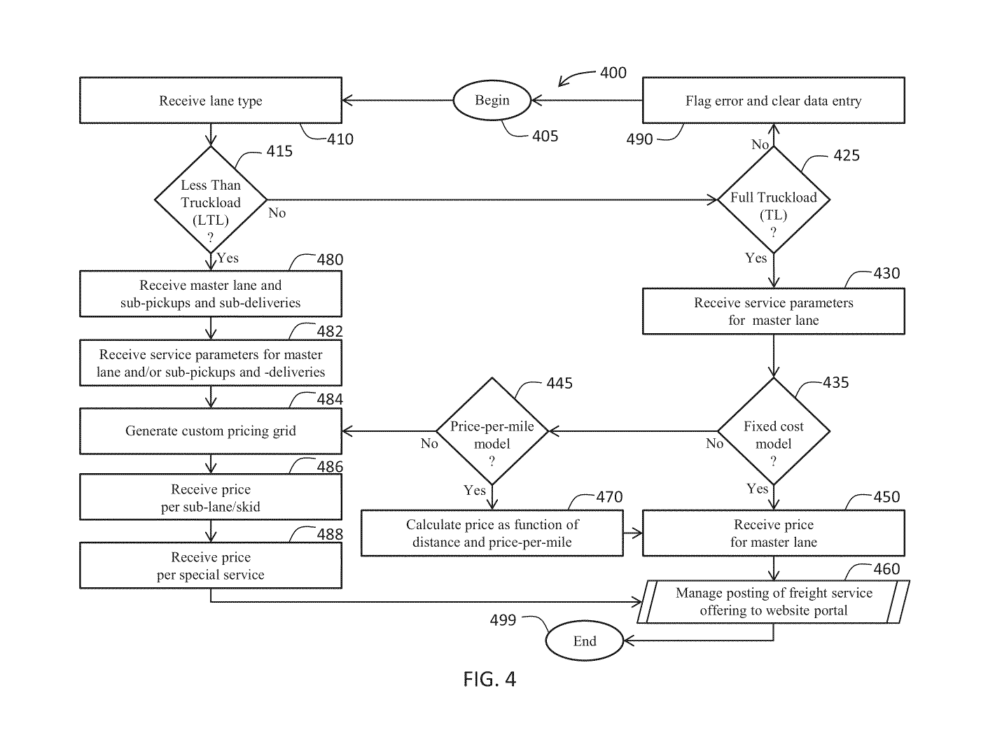

Referring now to FIG. 4, and continuing to refer to FIGS. 1, 2A, and 2B, a method aspect 400 for entering freight service offering information into the freight services marketplace system 100 will now be discussed in detail. More specifically, the entry of freight service offering parameters 210 from the carrier client 120 will now be discussed. The carrier may use a freight service creation interface on the carrier client 120 to instantiate a freight service offering data structure 210 and to transmit service parameters for that offering through a network 107 to the web server's network interface 106. For example and without limitation, the freight service creation interface may be in the form of a web-based application accessible through a web browser on the carrier client 120. The processor 102 may route the freight service offering information to the data store 103 on the data server 108.

At Block 410, the system 100 may receive from the carrier a lane type for the freight service offering 210. For example, and without limitation, the freight service offering may be characterized as a full truck load (FTL), as less than a truck load (LTL), as Both, or as Unlimited LTL. For definition purposes, a lane type of Both may signify that a carrier reserves the lane while deferring the decision as to whether the lane is FTL or LTL until shipper interest can be determined. For purposes of this disclosure, Both may be classified as a special case of LTL. Also for definition purposes, a lane type of Unlimited LTL may signify no limit may exist for the number of skids being marketed by the carrier. Unlimited LTL may be classified as a special case of LTL, and typically may be employed by medium or large carriers who are equipped to offer large shipping capacities to their customers.

If the lane type is not recognized at Block 415 as LTL (inclusive of the special cases of Both and Unlimited LTL) nor at Block 425 as FTL, then a data entry error may be flagged for the carrier by the system 100 (Block 490) and control may return to the beginning (Block 405) to allow the carrier to reenter the desired lane type correctly.

If, at Block 415, the lane type is recognized as LTL (or either of the special cases of Both or Unlimited LTL), then the system 100 may prompt the carrier to enter service parameters for a master lane and for a number of sub-pickups and sub-deliveries that may be included in the lane (Block 480). For purposes of definition, the term master lane refers to the core description of a lane. A sub-pick up or sub-delivery is a point outside of the radius covered by the master lane. For example, and without limitation, a lane may be from Chicago to Montreal with several sub-pickups and several sub-deliveries at intermediate locations generally along the route between the two cities. At Block 482, the carrier may enter into the system 100 additional service parameters for the freight service offering 210. As illustrated in FIG. 2B, the service parameters of interest may include those which can be used to match the requirements of a subsequently entered freight service request 220 such as, for example, and without limitation, pickup and delivery information (locations), skid space (including dimensions and weight allowance), availability, and transit time. At Block 484, the system 100 may generate a custom pricing grid for the master lane to facilitate the subsequent entry of pricing parameters for each sub-pickup/sub-delivery pair (Block 486) that the carrier may wish to offer for sale on the freight service marketplace system 100. As illustrated at Block 488, the carrier also may have the option to enter pricing parameters for special services related to a shipment, such as packaging, inspection, and other handling.

Referring again to FIG. 4 at Block 425, if the lane type is determined to be FTL, then the system 100 may prompt the carrier to enter service parameters for the master lane for the asset (Block 430). The master lane may be marketed as all available space comprising a shipping asset, and servicing pickup and delivery along a given transit route of the asset. As illustrated in FIGS. 2A and 2B, the service parameters of interest may include those which can be used to match the requirements of a subsequently entered freight service request 220 such as, for example, and without limitation, pickup and delivery information (locations), total trailer space (including dimensions and weight allowance), availability, and transit time.

If the carrier chooses to price the FTL freight service offering on a fixed cost model (Block 435), then the system 100 may receive a pricing parameter for the master lane (Block 450) that the carrier may wish to market on the freight service marketplace system 100. Alternatively, if the carrier chooses to price the freight service offering by the mile (Block 445), the system 100 may calculate the price of the freight service offering as a function of a pickup-to-delivery distance and a price-per-mile, both of which may be entered by the carrier (Block 470).

After pricing is complete either for an FTL offering (Block 450) or for an LTL or special case LTL offering (Block 488), the carrier may post the freight service offerings in the freight service marketplace system 100 as described below in more detail (Block 460) before the process may end at Block 499.

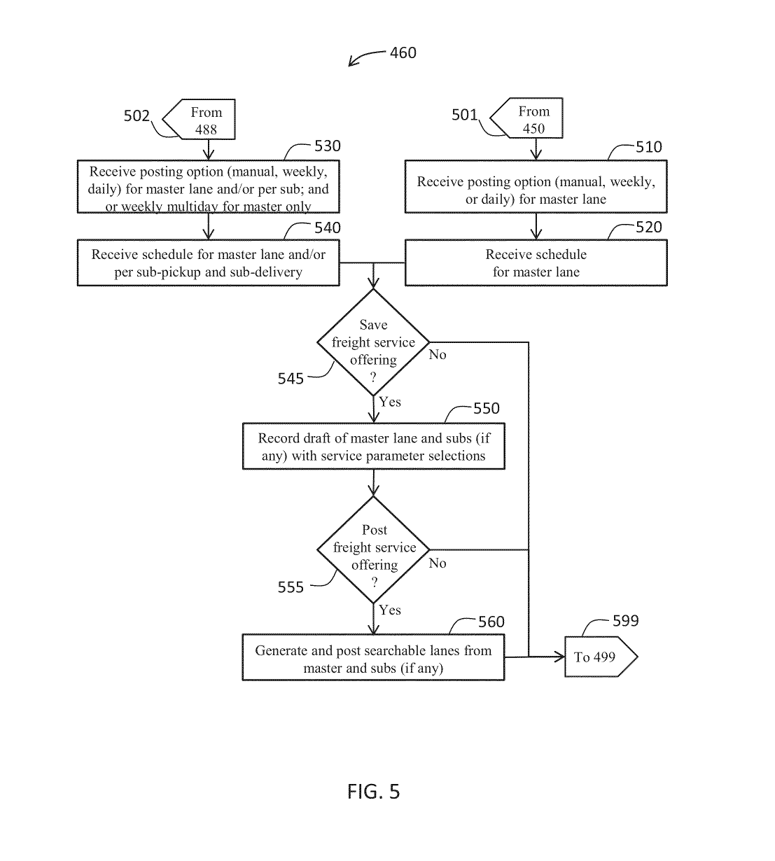

Referring now to FIG. 5, and continuing to refer to FIGS. 1, 2A, and 2B, a method aspect for posting a freight service offering schedule in the freight services marketplace system 100 will now be discussed in detail. Using the freight service offering data entry interface, posting of an FTL lane by a carrier may cause the process to begin at Block 501. The system 100 may receive from the carrier a posting option for the master lane (Block 510). For example, and without limitation, the available posting options may include manual (e.g., the lane may be posted on one specific day), daily (e.g., the lane may operate five days per week), and weekly (e.g., the lane may be posted on specific days during the week). At Block 520, the system 100 may receive a schedule for the master lane. For example, and without limitation, the carrier may enter specific pickup and delivery days (typically Monday through Friday) for the lane during the designated posting period (e.g., Thursdays of every week).

In another embodiment, posting of an LTL lane (or a special case of LTL) by a carrier may cause the process to begin at Block 502. The system 100 may receive from the carrier a posting option for the master lane and/or sub-pickups and sub-deliveries (Block 530). For example, and without limitation, the available posting options may include manual (e.g., the lane and/or sub-pickups and sub-deliveries may be posted on one specific day), daily (e.g., the lane and/or sub-pickups and sub-deliveries may operate five days per week), and weekly (e.g., the lane and/or sub-pickups and sub-deliveries may be posted on specific days during the week). In addition, for LTL lanes that require more than one day to fill a freight asset, a weekly multi-day pickup may be used to spread the master lane pick up over multiple days. Note that this option may not be available for sub pick-ups. At Block 540, the system 100 may receive a schedule for the master lane and/or sub-pickups and sub-deliveries. For example, and without limitation, the carrier may enter specific pickup and delivery days for the lane and/or for sub-pickups and sub-deliveries during the designated posting period.

Continuing to refer to FIG. 5, the system 100 may prompt the carrier to save the entered freight service offering information (Block 545). Saving the draft of the freight service offering data to the data store 103 on the data server 108 may record the service parameter selections for subsequent editing (Block 550). If the carrier opts not to save a draft at Block 545, then the freight service offering data entry may be lost and the data entry process may end at Block 599.

At Block 555, the system 100 may prompt the carrier to post the previously saved freight service offering for marketing to prospective customers. The carrier may elect to generate searchable lanes and/or sub-pickups and sub-deliveries (if any) for posting to the freight services marketplace (Block 560). Alternative, the carrier may elect not to post the offering to the freight services marketplace, opting instead to hide the draft offering from view of prospective customers and allowing the data entry process to end at Block 599.

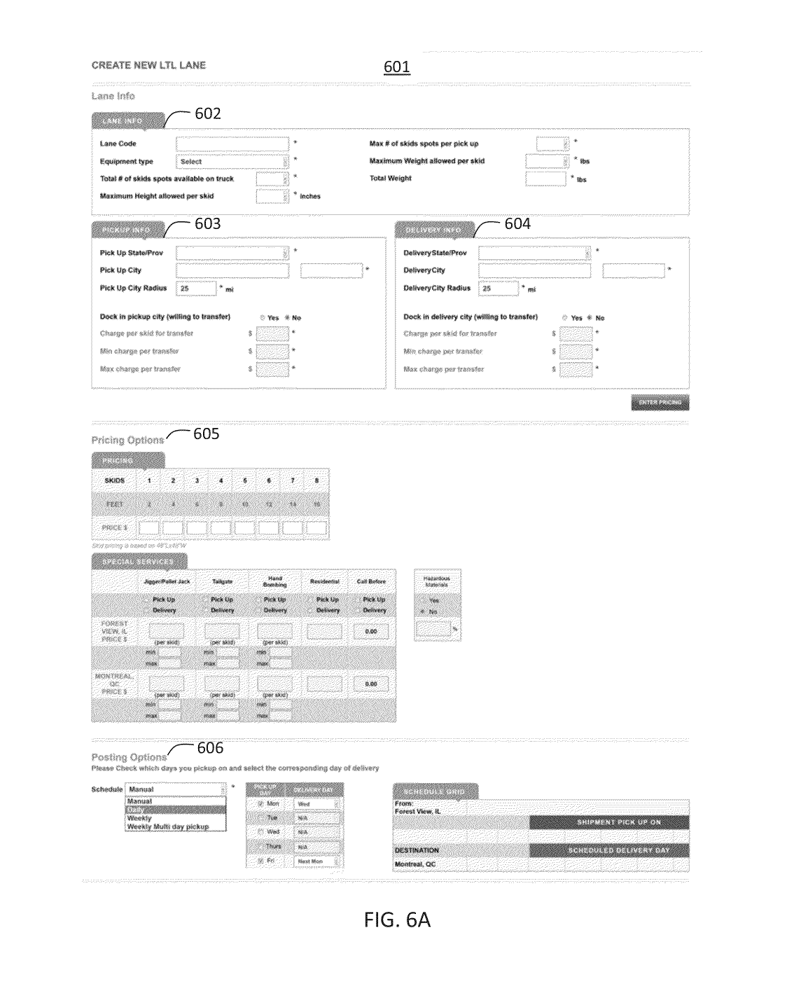

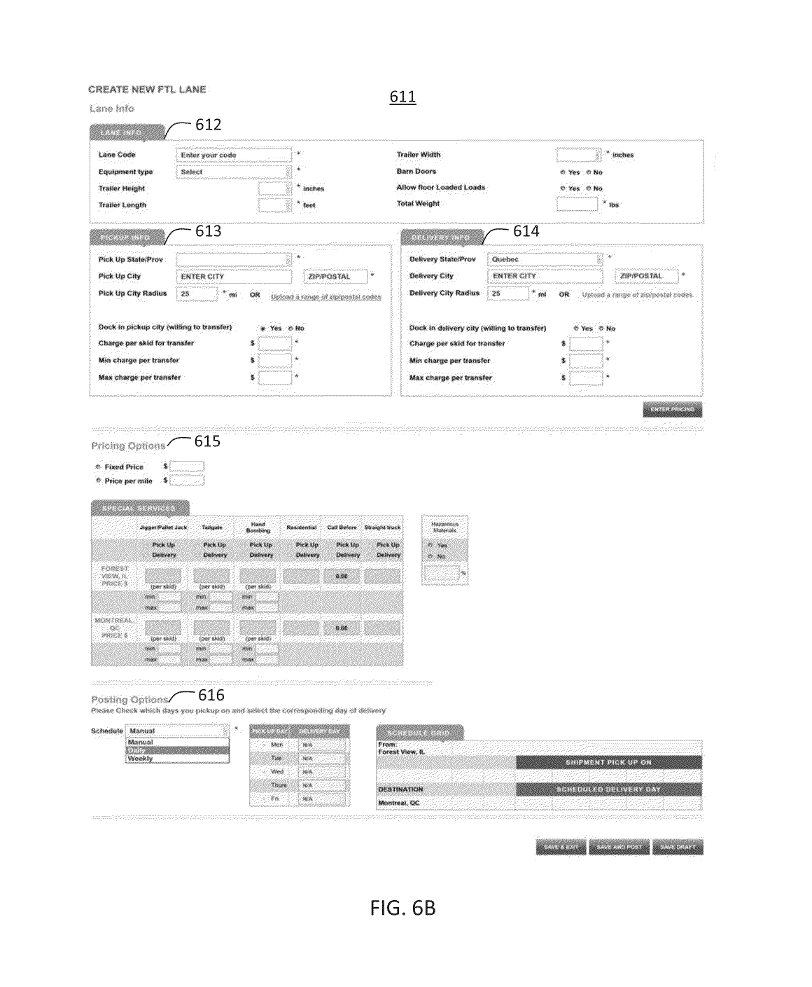

For example, and without limitation, FIG. 6A illustrates one embodiment of a system interface 601 to allow carrier creation of a freight service offering 210 of the LTL type. The system interface 601 may present displays for user entry of lane information 602, pickup information 603, delivery information 604, pricing options 605, and posting options 606 in keeping with the LTL data entry method described above.

Also for example, and without limitation, FIG. 6B illustrates one embodiment of a system interface 611 to allow carrier creation of a freight service offering 210 of the FTL type. The system interface 611 may present displays for user entry of lane information 612, pickup information 613, delivery information 614, pricing options 615, and posting options 616 in keeping with the FTL data entry method described above.

### Shipper Data Entry

Referring now to FIGS. 3A, 7, and 8, and continuing to refer to FIGS. 1 and 2A, a method aspect for entering shipper data into the freight services marketplace system 100, according to an embodiment of the present invention, will now be discussed. In the methods as illustrated herein, the carrier may use the shipper client 110 to interact with the web server 101. The following illustrative embodiment is included to provide clarity for certain operational methods that may be included within the scope of the present invention. A person of skill in the art will appreciate additional databases and operations that may be included within the freight services marketplace system 100 of the present invention, which are intended to be included herein and without limitation.

Referring again to FIG. 3A, and continuing to refer to FIGS. 1 and 2A, a method aspect 300 for creating a user account for a shipper in the freight services marketplace system 100 will now be discussed in detail. The shipper may use the account creation interface on the shipper client 110 to request a shipper account and to submit self-identifying information through a network 107 to the web server's network interface 106. For example and without limitation, the account creation interface may be in the form of a web-based application accessible through a web browser on the shipper client 110. The processor 102 may route the account creation information to the data store 103. As illustrated in FIG. 1, the data store 103 may be located on the web server 101 and/or on the data server 108.

At Block 310, the system 100 may receive from the shipper an account creation request. An appropriately-privileged administrator of account requests may use information captured by the system 100 to verify the role of the requestor in the shipping industry (Block 320). If the account administrator can identify the requestor as a shipper (Block 325), then the system may allow creation of the shipper account with preset access permissions to limit the account holder to access information on the system 100 on a standard, restricted basis (Block 330). For example, and without limitation, access controls may limit any identifying data stored by the shipper to not be viewable by soliciting carrier account holders. Such access controls may advantageously allow shippers to shop available freight service offerings using the freight services marketplace system 100 without exposing confidential customer data, such as contact information, to solicitors. Role based access controls also may privilege shipper account holders to invoke only those functions within the freight services marketplace system 100 for which the account of the user is approved. For example, and without limitation, a master account holder may be privileged to edit any information associated with a shipper account, including company contact and credit information. An operational account holder, defined as a Sub User, may be privileged only to order shipping and pay for shipping. A support account holder, such as a person in an accounting role, may be privileged only to view shipping purchase orders and to pay for orders, but not to book shipments.

Continuing to refer to FIG. 3A at Block 335, the system 100 may be used to check for preapproval of the credit of the shipper. At Block 340, the payment permissions of the shipper may be set by the system 100 to allow payment on credit if, for example, and without limitation, the shipper retains funds in a system account that are sufficient to cover payment for a particular requested freight service. Also for example, and without limitation, the system 100 may be configured to allow payment on credit if the shipper exhibits a good payment history. For shippers who do not enjoy preapproved credit, the payment permissions of the shipper may be set by the system 100 to allow credit card payment only (Block 370). After payment permissions are set, the process 300 may end at Block 375.

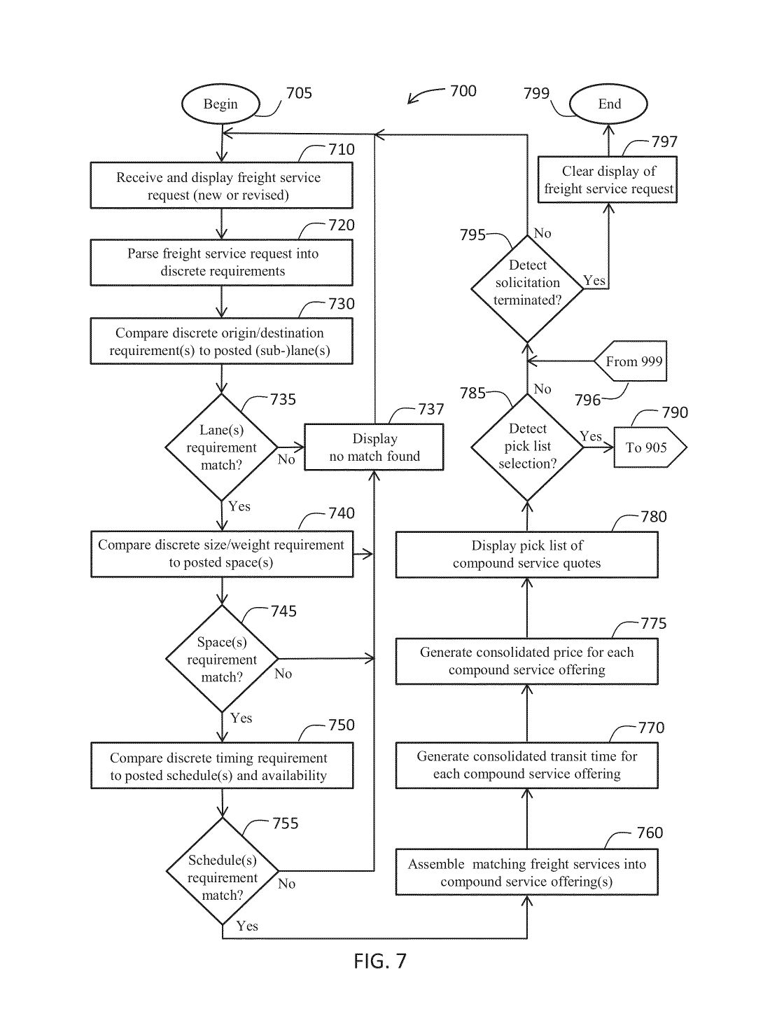

Referring now to FIG. 7, and continuing to refer to FIGS. 1 and 2A, a method aspect 700 for entering freight service request information into the freight services marketplace system 100 will now be discussed in detail. More specifically, the entry of the freight service request 220 from the shipper client 110 will now be discussed. The shipper may use a freight request creation interface on the shipper client 110 to develop a freight service request and to transmit load parameters for that offering through a network 107 to the web server's network interface 106. For example and without limitation, the freight service request creation interface may be in the form of a web-based application accessible through a web browser on the shipper client 110. The processor 102 may route the freight service request information to the data store 103.

From the beginning 705, the system 100 may receive from the shipper a freight service request (Block 710). For example and without limitation, a freight service request data entry interface may be in the form of a web-based application accessible through a web browser on the shipper client 110. The web browser within the shipper client 110 may allow the shipper to submit load parameters 220 to the web server 101 which may, in turn, be written to the data server 108.

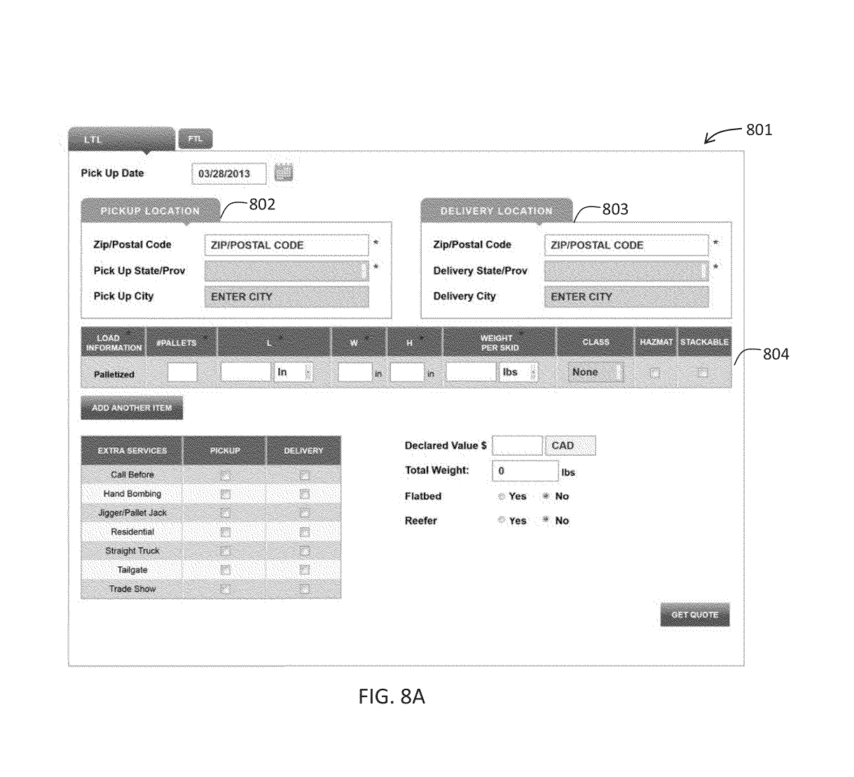

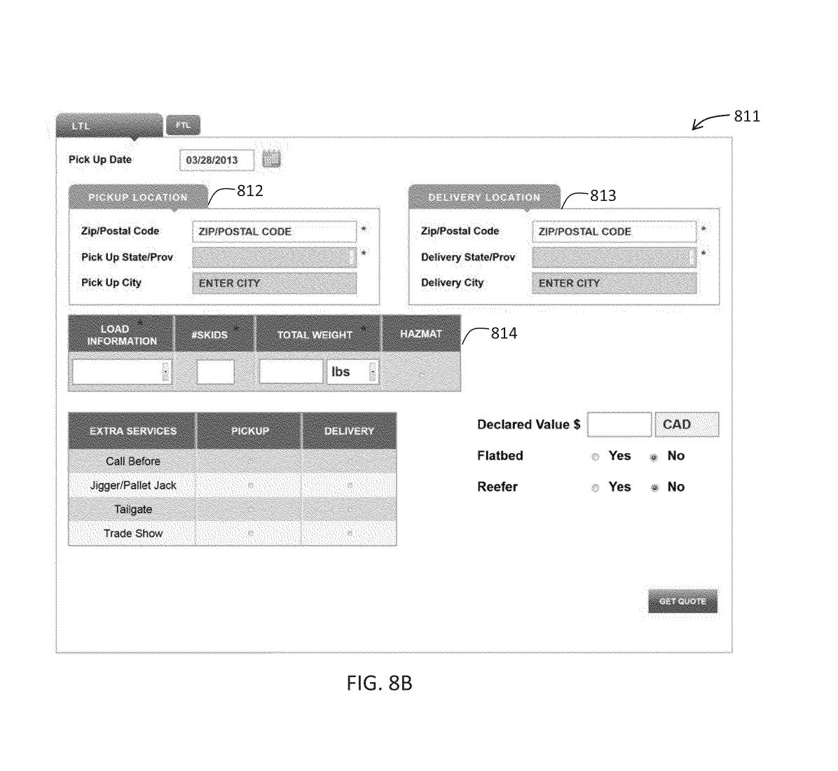

For example, and without limitation, FIG. 8A illustrates one embodiment of a system interface 801 to allow shipper creation of a freight service request 220 of the LTL type. The system interface 801 may present displays for user entry of pickup location 802, delivery location 803, and load characteristics 804 in keeping with the LTL data entry method described above. A shown in the illustration 801, an LTL may require entry of the physical characteristics of the load 804, because such information may be needed to plan for reservation of less than the total space available in a freight asset (e.g., sharing of a truck).

For example, and without limitation, FIG. 8B illustrates one embodiment of a system interface 811 to allow shipper creation of a freight service request 220 of the FTL type. The system interface 811 may present displays for user entry of pickup location 812, delivery location 813, and load characteristics 814 in keeping with the FTL data entry method described above. A shown in the illustration 811, an FTL may require entry of the capacity of the freight asset 814, because the reservation may be for the entire vehicle (e.g., truck).

### Matching

Referring now to FIGS. 7, 9 and 10, and continuing to refer to FIGS. 1, 2A, and 2B, a method aspect for matching the freight service request of a shipper to the freight service offerings of one or more carriers using the freight services marketplace system 100, according to an embodiment of the present invention, will now be discussed. In the methods as illustrated herein, the matching engine 104 executing on the processor 102 of the web server 101 may operate on the data structures 130 that may be located in the data store 103 of the data server 108. For example, and without limitation, a shipper may use the shipper client 110, and one or more carriers may use a respective carrier client 120, each to interact with the web server 101. The following illustrative embodiment is included to provide clarity for certain operational methods that may be included within the scope of the present invention. A person of skill in the art will appreciate additional databases and operations that may be included within the freight services marketplace system 100 of the present invention, which are intended to be included herein and without limitation.

Referring again to FIG. 7 at Block 720, the matching engine 104 may parse the freight service request into discreet requirements of the shipper. Each requirement may be expressed at the level of abstraction of a fundamental load parameter that may be compared against the service parameter(s) of a given freight service offering. For example, and without limitation, the freight service request may be parsed into discreet requirements 220 for origin and destination, for size and weight, and for shipment timing.

At Blocks 730, 740, and 750, the matching engine 104 may compare each of the discrete requirements of the freight service request to service parameters of freight service offerings entered by carriers and/or retrieved from third-party freight service information sources. As a result of this comparison process, the matching engine 104 may use suitability criteria to reduce the full set of stored freight service offerings to a smaller set of available freight service offerings capable of satisfying each requirement of the freight service request. Eliminating freight service offerings from consideration based on suitability criteria advantageously may promote carrier efficiency by reducing information traffic upon which the carrier cannot act and, therefore, has no need to receive.

More specifically, the matching engine 104 may identify one or more freight shipping assets that, either individually or in combination, meet all discreet requirements in the freight service request. For example, and without limitation, the processor 102 may retrieve information on a set of available assets (either staged from the data store 103 or imported directly from third-party information sources). The retrieved information may contain service parameters for each asset in the set, including the lanes serviced (Block 730), the spatial characteristics of the asset (Block 740), and the scheduling of the asset (Block 750). Scheduling parameters may include the available dates of that asset, the location of the asset on the required dates, and the billable units for lease on the asset on the required dates.

If no single asset nor combination of assets is found by the matching engine 104 to satisfy the lane (Block 735), space (Block 745), nor schedule (Block 755) requirements of the original freight service request, then the matching engine 104 may communicate to the shipper (for example, through the browser on the shipper client 110) that no matching assets were found to deliver the requested service (Block 737). In this eventuality, the shipper may be allowed to revise her freight service request at Block 710.

At Block 760, the matching engine may assemble complementary freight service offerings submitted by carriers through the use of carrier client 120 into one or more compound service offerings for the requested freight service. For purposes of definition, the term “compound service offering” may refer to a consumer having the ability to arrange and pay collectively for services received related to a single freight transport event, rather than having to schedule and pay separately for each event-related service delivered by each of multiple providers of shipping assets, personnel, and/or support services. To facilitate treatment of each compound service offering as an individually marketed and managed unit, the system 100 may generate a single, consolidated transit time for the offering (Block 770) by adding the transit times of the freight service offerings comprising the compound service offering. Similarly, the system 100 may generate a single, consolidated price for the offering (Block 775) by summing the prices of the freight service offerings comprising the compound service offering.

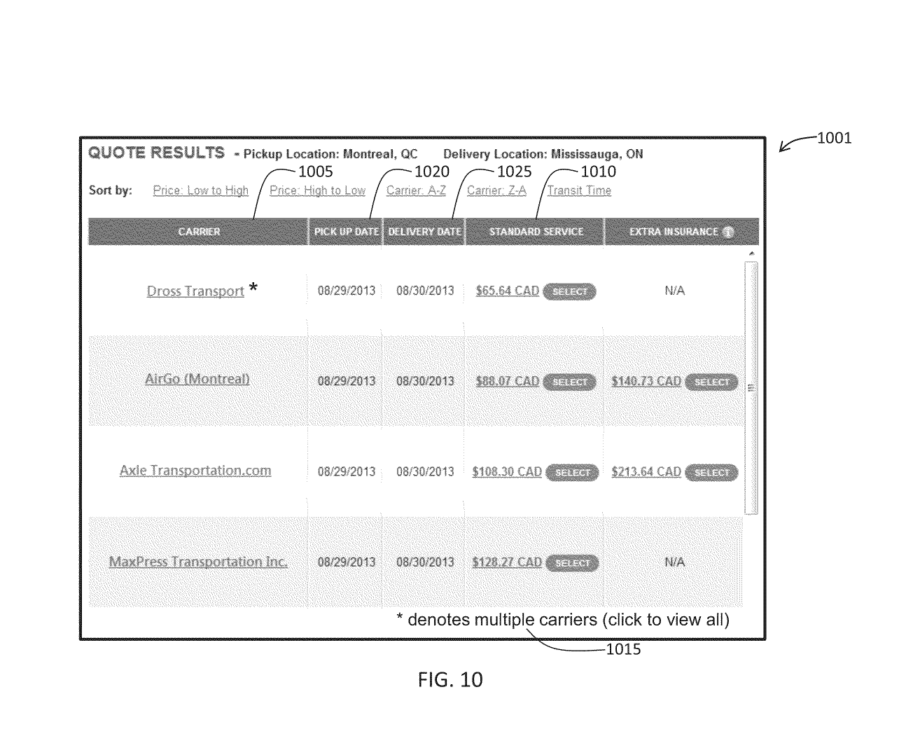

At Block 780, the compound service quotes may be viewed in real-time by a shipper using the web browser of the shipper client 110. More specifically, the matching engine 104 may display a pick list of combined service quotes that may be viewable from the web browser of a shipper client 110. For example, and without limitation, FIG. 10 illustrates one embodiment of a system interface 1001 to allow the shipper to select from a list of marketed freight service offerings 210 that may meet the freight service request 220 requirements of the shipper. The system interface 1001 may display candidate carriers 1005 and freight prices 1010 in keeping with the quoting method described above. The system interface 1001 also may display an absolute pickup date 1020 and delivery date 1025 for each freight service offering, as calculated from the pickup and delivery days of the week specified during lane creation by the candidate carrier for each freight service offering. A candidate carrier may be represented as a link to multiple carriers 1015 who may collaborate to provide a combined freight service offering.

The pick list of quotes from candidate carriers may be active for a fixed period of time. Before this period of time has ended, as monitored at Block 795 in FIG. 7, the shipper may have the option of selecting one of the compound service quotes from the pick list (Block 785). If a selection of a quote from the pick list is detected by the matching engine 104 at Block 785, then the method may proceed at Block 790 to the provisioning process described in more detail below. At any time before the solicitation period terminates (Block 795), the shipper may be allowed to revise her freight service request at Block 710. Similarly, if the solicitation is not terminated (Block 795) as a result of successful completion of the provisioning process (Block 796), the shipper may be allowed to revise her freight service request at Block 710. However, if at Block 795 no quote for freight service is selected by the shipper before the solicitation is terminated (e.g., withdrawal by shipper, expiration of time period), then at Block 797 the freight service request may be removed from active solicitations by the web server 101 before the method ends at Block 799.

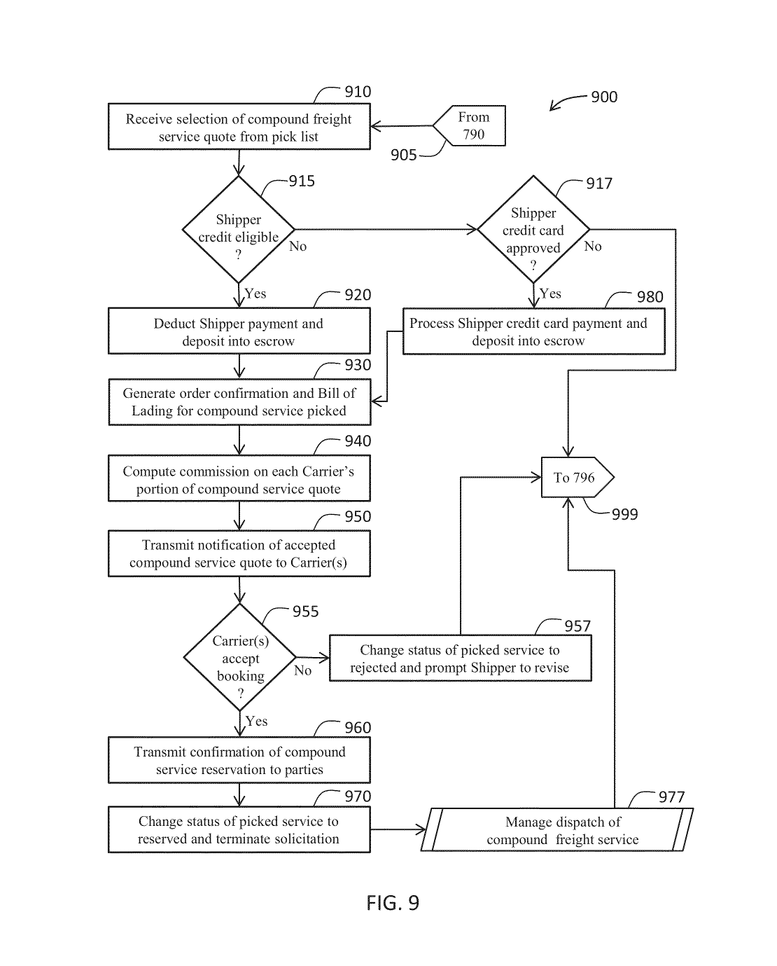

Referring now to FIG. 9 and beginning at Block 905, the matching engine 104 may process the operations necessary to provision a freight shipping service transaction 900, including, but not limited to, processing of freight service reservations, party notifications, and customer payments. At Block 910, the system 100 may receive the compound freight service quote selected by the shipper from the pick list. More specifically, the shipper may use a browser to transmit acceptance of a bundled service quote through a network 107 to the web server's network interface 106. The dispatch engine 105 may transmit notification of bid acceptance to the communication address provided in the carrier information 210. More specifically, this communication may notify the carrier that his service offering has been chosen by a shipper to fulfill some portion of the given freight service request 220. For example, and without limitation, the notification may include a commission invoice.

The matching engine 104 may process shipper payment for freight services facilitated using the system 100. More specifically, at Block 915, if the shipper is eligible to make payment from a system-controlled credit account, then the system 100 may deduct the consolidated price of the compound service offering selected by the shipper and deposit that amount into an escrow account pending successful delivery of the freight service (Block 920). Alternatively, or in addition, if the shipper is eligible to make payment by credit card (Block 917), then the system 100 may charge the card for the consolidated price of the compound service offering selected and deposit that amount into an escrow account (Block 980). If the system 100 cannot determine the eligibility of the shipper to make payment (Blocks 915, 917), then the provisioning process may end without depositing funds into escrow and may prepare for termination of the solicitation (Block 999).

Although the process illustrated in FIG. 9 presumes escrow of shipper payments, those skilled in the art will appreciate that other payment processing models are within the scope and spirit of the disclosed invention. For example, and without limitation, the matching engine 104 may be configured to receive from each carrier involved in a combined service offering confirmation of receipt of direct payment from the shipper. Direct payments from the shipper to the carrier(s) involved may cause the matching engine 104 to await notice from the carrier(s) of receipt and processing of each carrier's portion of the total payment before generating shipping artifacts (Block 930).

After successful processing of shipper payment (either of Blocks 920 and 980), the system may automatically generate industry-standard shipping documents, such as order confirmations and Bills of Lading for each freight service offering comprising the selected compound service offering (Block 930). At Block 940, the dispatch engine 105 may automatically compute a commission to be paid, for example, and without limitation, by either or both of the parties to the freight service transaction in return for facilitation of the transaction by the freight services marketplace system 100. The efficiencies introduced by the automation in the present embodiment, and by the obviation of the need for broker services, advantageously may result in administrative charges and commission rates much lower than those demanded by traditional freight brokerages.

At Block 950, the matching engine 104 may transmit notification of shipper acceptance of the compound service quote to the carrier(s) who must cooperate to deliver each freight service offering comprising that compound service. More specifically, the matching engine 104 may send freight request solicitations in the form of email to carrier clients 120 to inform each carrier that he is a suitable match to fulfill a requirement present in a given freight service request. For example, and without limitation, the solicitation may contain a hyperlink to a web page where the carrier may view request details. Carriers who do not post freight service offerings that match the selection criteria expressed as freight request requirements may not be notified of the freight request by the matching engine 104. Automatic, proactive filtering of unwanted solicitations from other than qualified carriers advantageously may obviate the need for carriers to review and discard moot freight requests, and/or to perform time-consuming and inefficient searches for service delivery opportunities.

After viewing the solicitation, the matching carriers may decide whether to accept the booking of their respective freight service offerings as part of the given freight service request (Block 955). Specifically, a solicitation response interface may be provided in the form of a web-based application accessible through a web browser on the carrier client 120. A web browser within the carrier client 120 may allow the carrier to submit an acceptance using the solicitation response interface within web server 101.

If solicitations for all freight service offerings comprising the compound service offering are accepted at Block 955, then the system 100 may transmit confirmation of the reservation of compound freight service offering to both the shipper and the involved carrier(s) (Block 960). For example, and without limitation, the confirmation may be communicated in the form of an email containing dispatch information and contact details of the other party. Confirmation of a reservation may signify termination of a solicitation period for the associated freight service request, causing the matching engine 104 to remove booked freight service requests from postings available for sale (Block 970).

For example, and without limitation, while a freight service is being provisioned as described above, the service parameter for status of the freight service offering data structure 210 may be updated using the system 100 to reflect milestones such as the following:

Needs Confirmation/View Order—A shipper is purchasing some of the shipping capacity

Confirmed—A carrier has accepted a purchase order for the booked lane

Declined—A carrier has declined a purchase order for the booked lane

Continuing to refer to FIG. 9, if the solicitation for any one of the freight service offerings comprising the compound service offering is rejected at Block 955 (for example, and without limitation, the freight service offering status is set to Declined), then the system 100 may allow the solicitation period for the associated freight service request to remain active and may prompt the shipper to revise the freight service request (Block 957) or, alternatively, to allow the termination of the solicitation (Block 999). If acceptance of the compound service offering booking is detected by the matching engine 104 at Block 955 (for example, and without limitation, the statuses for all freight service offerings included in the compound service offering are set to Confirmed), then the method may proceed to the dispatch process (Block 977) described in more detail below.

### Dispatch

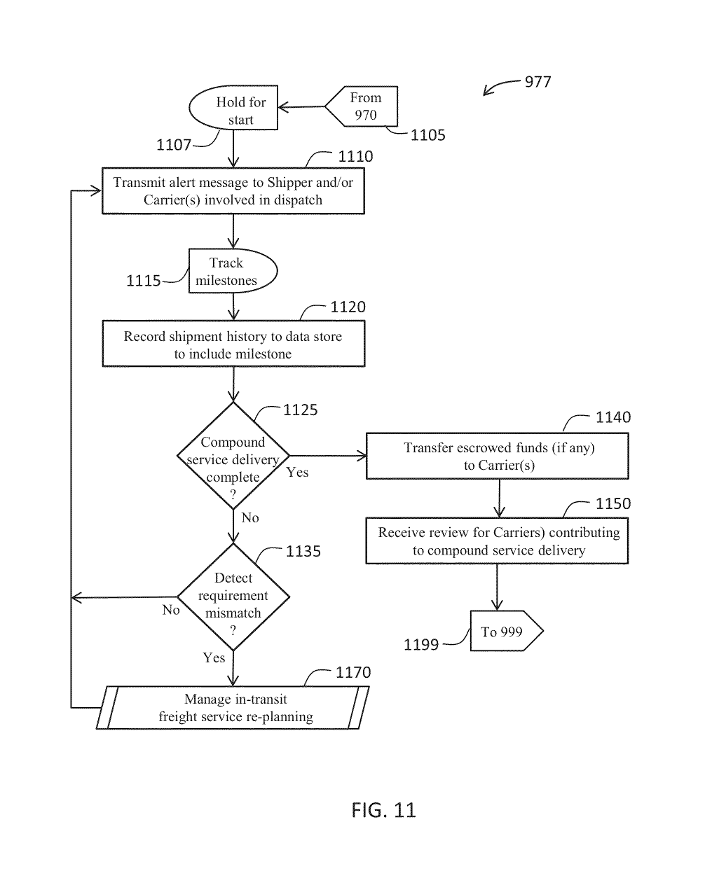

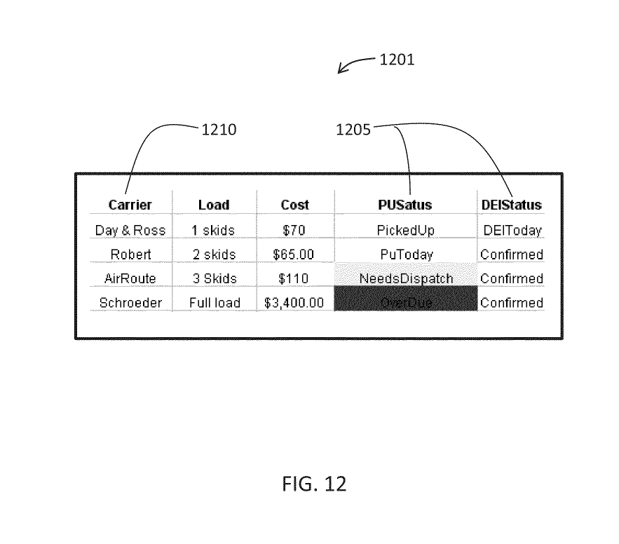

Referring now to FIGS. 11 and 12, and continuing to refer to FIGS. 1, 2A, and 2B, a method aspect for managing the dispatch of the compound freight service using the freight services marketplace system 100, according to an embodiment of the present invention, will now be discussed. In the methods as illustrated herein, the dispatch engine 105 executing on the processor 102 of the web server 101 may operate on the data structures 130 that may be located in the data store 103 of the data server 108. The following illustrative embodiment is included to provide clarity for certain operational methods that may be included within the scope of the present invention. A person of skill in the art will appreciate additional databases and operations that may be included within the freight services marketplace system 100 of the present invention, which are intended to be included herein and without limitation.

Referring again to FIG. 11 at Block 1107, the dispatch engine 104 may monitor the pickup schedule for reserved freight service offerings. At some time prior to the pickup date of the compound delivery service, the system 100 may transmit alert messages to the shipper and/or to the carrier(s) involved in delivery of the compound freight service (Block 1110). The alert messages may prompt service initiation activity on the parts of the parties to the freight transaction, thereby minimizing the opportunity for human error that may jeopardize the start of the shipment.

The system 100 may be configured to receive status updates from carrier personnel as key milestones are achieved in satisfaction of each freight service offering included in the compound service offering (Block 1115). For example, and without limitation, while a load is in transit, the service parameter for status of the freight service offering data structure 210 may be updated using the system 100 to reflect milestones such as the following:

Dispatch Pick Up—A carrier must dispatch an asset to collect the freight

Pick Up Dispatched—A carrier has dispatched a freight asset

Pick Up Need Confirm—A carrier has dispatched a freight asset and the pick up time has passed

Pick Up Confirmed—A carrier has picked up the load

Actual Pick Up—Recording of the time the freight was collected

Dispatch Delivery—A carrier must dispatch an asset to deliver the freight

Delivery Dispatched—A carrier has dispatched an asset

Delivery Need Confirm—A carrier has dispatched an asset and the delivery time has passed

Actual Delivery—Recording of the time the freight was delivered

Delivery Confirmed—Freight delivered

On Hold—Delay encountered

The system 100 may write each status change to the data store 103 to compile a shipment history for subsequent analysis and reporting purposes (Block 1120). Monitoring and recording of milestones may continue throughout the delivery process until the compound delivery service is complete (Block 1125). For example, and without limitation, FIG. 12 illustrates one embodiment of a system interface 1201 to allow the shipper to monitor the status 1205 of the booked freight service offering 220. The system interface 1001 may display a record for each of multiple carriers 1210 who may collaborate to provide a combined freight service offering.

Milestone and status tracking of shipping assets may be accomplished not only for the asset with which the load may be actively engaged, but also for downstream assets. For example, and without limitation, at Block 1135 the system 100 may detect that a freight service offering included in the compound service offering underway may for some reason become unavailable (for example, the status may be set to On Hold due to a delay caused by an accident involving the asset, or by a double-booking error that may prevent the carrier from honoring a commitment to provide an asset). In such an eventuality, the system 100 may attempt to automatically identify and reserve an alternative asset to replace the freight service offering that has become unavailable to the compound service offering already in progress (Block 1170). This re-planning method of Block 1170 is described in more detail below.

In one embodiment, for example, and without limitation, the dispatch engine 105 may employ traditional escrow rules by monitoring for the completion of the freight service offering provisioned using the system 100 (Block 1125). Upon completion of each carrier's contractual obligation related to the subject freight service, the dispatch engine 105 may automatically release any escrowed funds piecemeal to the responsible carrier(s) at Block 1140. In another embodiment, for example, and without limitation, the dispatch engine 105 may employ flow-through purchase escrow rules (not shown) by transferring shipper payment to the involved carriers upon the start of each freight service offering (as monitored at Block 1115), less a deduction for commission in return for facilitation of the freight service transaction by the freight services marketplace system 100.

Continuing to refer to FIG. 11, the dispatch engine 105 may feature a mechanism for receiving and recording shipper reviews for one or more carrier(s) who contributed to the combined freight service delivery (Block 1150). Referring additionally to FIG. 7, the method may end at Block 1199, after which tracking of the freight service request by the web server 101 may be cleared (at Block 797) before the method ends at Block 799.

### Re-planning

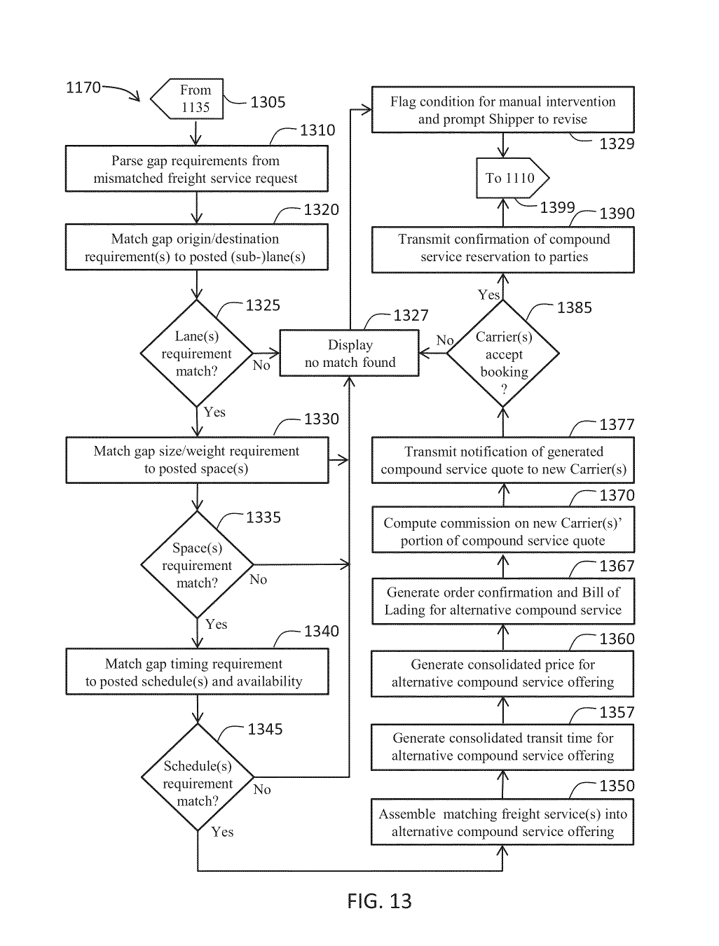

Referring now to FIG. 13, and continuing to refer to FIGS. 1, 2A, and 2B, a method aspect for managing in-transit freight service re-planning using the freight services marketplace system 100, according to an embodiment of the present invention, will now be discussed. The following illustrative embodiment is included to provide clarity for certain operational methods that may be included within the scope of the present invention. A person of skill in the art will appreciate additional databases and operations that may be included within the freight services marketplace system 100 of the present invention, which are intended to be included herein and without limitation.

Referring again to FIG. 13 beginning at Block 1305, the dispatch engine 104 may respond to the detection of a freight request requirement mismatch by automatically applying a matching process to identify and reserve an alternative freight service offering. The purpose of the alternative freight service offering may be to replace an asset in the compound service offering that has otherwise become unavailable. The re-planning process may be similar to the matching process described above, with the exception that much of the human-in-the-loop decision making may be omitted (e.g., shipper selection from among several alternative freight service offerings) as long as the original contractual terms of the freight transaction (e.g., total price) are not violated.

Referring again to FIG. 13 at Block 1310, the matching engine 104 may parse the unfulfilled requirements (referred to as “gap” requirements) from the original freight service request into discreet requirements. For example, and without limitation, the freight service request 220 may be parsed into discreet requirements for origin and destination, for size and weight, and ship dates.

At Blocks 1320, 1330, and 1340, the matching engine 104 may compare each of the gap requirements of the freight service request to service parameters of freight service offerings entered by carriers and/or retrieved from third-party freight service information sources. As a result of this comparison process, the matching engine 104 may use suitability criteria to reduce the full set of stored freight service offerings to a smaller set of available freight service offerings capable of satisfying the gap requirement. For example, and without limitation, the processor 102 may retrieve information on available assets (either staged from the data store 103 or directly from third-party information sources) containing service parameters for each asset in the set, including the lanes serviced (Block 1320), the spatial characteristics of the asset (Block 1330), and the scheduling of the asset (Block 1340).

If no single alternative asset nor combination of alternative assets is found by the matching engine 104 to satisfy the lane (Block 1325), space (Block 1335), nor schedule (Block 1345) gap requirements of the original freight service request, then the matching engine 104 may communicate to the appropriate parties (for example, to the shipper through the browser on the shipper client 110) that automatic re-planning has failed (Block 1327) and that manual intervention may be needed to accomplish the shipment already in progress (Block 1329). In this eventuality, the shipper may be allowed to revise her freight service request (Block 1110).

At Block 1350, the matching engine may assemble complementary freight service offerings submitted by carriers through the use of carrier client 120 into one or more alternative compound service offerings for the requested freight service. The system 100 may generate a single, consolidated transit time for the offering (Block 1357) by adding the transit times of the freight service offerings comprising the alternative compound service offering. Similarly, the system 100 may generate a single, consolidated price for the offering (Block 1360) by summing the prices of the freight service offerings comprising the alternative compound service offering.

At Block 1367, the system 100 may automatically generate industry-standard shipping artifacts, such as order confirmations and Bills of Lading for the alternative freight service offering that was newly added to the compound service offering already in progress (Block 1360). Presuming the alternative freight service offering may be added to the combined service offering already in progress without violating the consolidated price and consolidated transit time terms contractually agreed to by the shipper, then proactive selection and/or approval of the alternative freight service offering by the shipper may not be required.

At Block 1370, the dispatch engine 105 may automatically compute a commission to be paid by the provider of the alternative freight service offering in return for facilitation of the freight service transaction by the freight services marketplace system 100. At Block 1377, the matching engine 104 may transmit notification of the alternative compound service quote to the carrier(s) responsible for delivering the alternative freight service offering. More specifically, the matching engine 104 may send freight request solicitations in the form of email to carrier clients 120 to inform each carrier that he is a suitable match to fulfill the gap requirement present in a given freight service request. For example, and without limitation, the solicitation may contain a hyperlink to a web page where the carrier may view request details.

After viewing the solicitation, the new carriers may decide whether to accept the booking of their respective freight service offerings as part of the alternative compound service offering (Block 1385). Specifically, a solicitation response interface may be provided in the form of a web-based application accessible through a web browser on the carrier client 120. A web browser within the carrier client 120 may allow the carrier to submit an acceptance using the solicitation response interface within web server 101.

If the solicitation for the alternative freight service offering is accepted at Block 1385, then the system 100 may transmit confirmation of the reservation of the alternative freight service in keeping with the accepted booking to both the shipper and the involved carrier(s) (Block 1390). For example, and without limitation, the confirmation may be communicated in the form of an email containing dispatch information and contact details of the other party.

If the solicitation for the alternative freight service offering is rejected at Block 1385, and no other candidate freight service offerings meet the gap requirement(s), then the matching engine 104 may communicate to the shipper (for example, through the browser on the shipper client 110) that automatic re-planning has failed (Block 1327) and that manual intervention may be needed to accomplish the shipment already in progress (Block 1329).

### Computing Environment

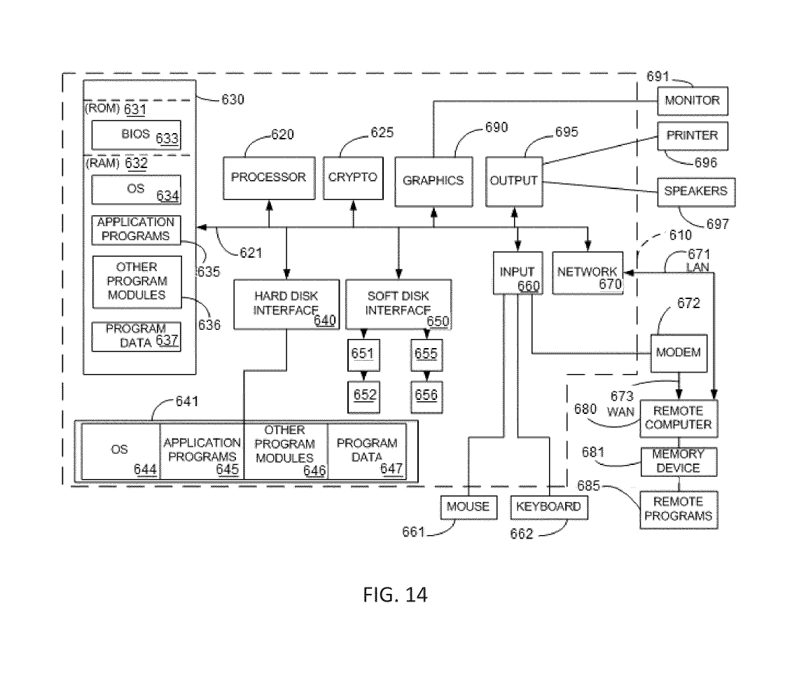

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 14 illustrates a model computing device in the form of a computer 610, which is capable of performing one or more computer-implemented steps in practicing the method aspects of the present invention. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 610 may also include a cryptographic unit 625. Briefly, the cryptographic unit 625 has a calculation function that may be used to verify digital signatures, calculate hashes, digitally sign hash values, and encrypt or decrypt data. The cryptographic unit 625 may also have a protected memory for storing keys and other secret data. In other embodiments, the functions of the cryptographic unit may be instantiated in software and run via the operating system.

A computer 610 typically includes a variety of computer readable media. Computer readable media can be any available media that can be accessed by a computer 610 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 14 illustrates an operating system (OS) 634, application programs 635, other program modules 636, and program data 637.

The computer 610 may also include other removable/non-removable, volatile/nonvolatile computer storage media. By way of example only, FIG. 14 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives, and their associated computer storage media discussed above and illustrated in FIG. 14, provide storage of computer readable instructions, data structures, program modules and other data for the computer 610. In FIG. 14, for example, hard disk drive 641 is illustrated as storing an OS 644, application programs 645, other program modules 646, and program data 647. Note that these components can either be the same as or different from OS 633, application programs 633, other program modules 636, and program data 637. The OS 644, application programs 645, other program modules 646, and program data 647 are given different numbers here to illustrate that, at a minimum, they may be different copies. A user may enter commands and information into the computer 610 through input devices such as a keyboard 662 and cursor control device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a graphics controller 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 14. The logical connections depicted in FIG. 14 include a local area network (LAN) 671 and a wide area network (WAN) 673, but may also include other networks 140. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 14 illustrates remote application programs 685 as residing on memory device 681.

The communications connections 670 and 672 allow the device to communicate with other devices. The communications connections 670 and 672 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. The scope of the invention should be determined by the appended claims and their legal equivalents, and not by the examples given Therefore, it is understood that the invention is not to be limited to the specific embodiments disclosed.

What is claimed is:

1. A method of facilitating freight transactions comprising:
receiving at least one freight service offering from each of a plurality of carriers using a website portal accessible from a communications network, wherein each of the freight service offerings is characterized by service parameters comprising a lane, a space, a transit time, an availability, and a price;
receiving a freight service request from a shipper using the website portal, wherein the freight service request is characterized by load parameters comprising an origin, a destination, a size, and a weight;
generating a compound service offering comprising more than one of the freight service offerings and having service parameters that accommodate the load parameters of the freight service request;
receiving, from the shipper, a selected compound service offering that is selected from the compound service offering generated to accommodate the load parameters of the freight service request;
reserving the selected compound service offering; and
dispatching the selected compound service offering.

2. The method according to claim 1 wherein receiving at least one freight service offering from each of the plurality of carriers comprises:
processing a carrier registration of each of the plurality of carriers to access the website portal;
verifying the carrier registration of the each of the plurality of carriers upon accessing the website portal; and
restricting each of the plurality of carriers from using the website portal to access confidential carrier information, wherein confidential carrier information comprises the price of the freight service offering of another of the plurality of carriers.

3. The method according to claim 2 wherein receiving the freight service request from the shipper comprises:
processing a shipper registration of the shipper to access the website portal;
verifying the registration of the shipper upon accessing the website portal; and
restricting each of the plurality of carriers from using the website portal to access confidential shipper information, wherein the confidential shipper information comprises a name of the shipper.

4. The method according to claim 1 wherein generating the compound service offering further comprises:
identifying a combination of the lanes of the freight service offerings included in the compound service offering that accommodates the origin and the destination of the freight service request;
identifying the respective space of each of the freight service offerings included in the compound service offering that accommodates the size and the weight of the freight service request; and
identifying the respective availability of each of the freight service offerings included in the compound service offering is set to indicate that the freight service offering is available for reservation.

5. The method according to claim 1 wherein generating the compound service offering further comprises:
generating a consolidated freight service transit time defined as a combination of the transit times of the freight service offerings included in the compound service offering; and
generating a consolidated freight service price defined as a sum of the prices of the freight service offerings included in the compound service offering.

6. The method according to claim 1 wherein receiving the selected compound service offering further comprises setting the respective availability of each of the freight service offerings included in the selected compound service offering to indicate that freight service offering is not available for reservation.

7. The method according to claim 5 wherein reserving the selected compound service offering further comprises receiving an escrow payment in the form of at least one of a system credit and a credit card payment, wherein the escrow payment is computed as including the consolidated freight service price for the selected compound service offering.

8. The method according to claim 6 wherein the service parameters of each of the plurality of freight service offerings further comprise a status, and wherein dispatching the selected compound service offering further comprises:
monitoring the status of each of the freight service offerings included in the selected compound service offering, defined as a monitored service offering; and
sending an alert message to at least one of the shipper and the carrier from which the monitored service offering was received, wherein the alert message communicates the status of the monitored service offering.

9. The method according to claim 6 wherein the service parameters of each of the plurality of freight service offerings further comprise a status, and wherein dispatching the selected compound service offering further comprises:
monitoring the status of each of the freight service offerings included in the selected compound service offering, defined as a monitored service offering;
identifying a freight service offering included in the monitored service offering that has at least one service parameter that does not accommodate the load parameters of the freight service request;
generating an alternative compound service offering comprising more than one of the freight service offerings and having service parameters that accommodate the load parameters of the freight service request;
reserving the alternative compound service offering;
dispatching the alternative compound service offering; and
sending an alert message to the carrier from which the monitored service offering was received, wherein the alert message communicates the status of the monitored service offering.

10. The method according to claim 7 wherein the service parameters of each of the plurality of freight service offerings further comprise a status, and wherein dispatching the selected compound service offering further comprises:
monitoring the status of each of the freight service offerings included in the selected compound service offering, defined as a monitored service offering;
identifying delivery completion defined as setting the respective status of each of the freight service offerings in the monitored service offering to indicate that the freight service offering in the monitored service offering is complete; and
remitting a service payment to the carrier from which the monitored service was received, wherein the service payment is computed as including the price for the monitored service offering and is deducted from the escrow payment.

11. A computer program product embodied in a computer-readable storage medium for facilitating freight transactions comprising:
a data store, and
a website portal accessible from a communications network and in data communication with the data store, the website portal configured to
receive at least one freight service offering from each of a plurality of carriers, wherein each of the freight service offerings is characterized by service parameters comprising a lane, a space, a transit time, an availability, and a price;
save the freight service offerings to the data store;
receive a freight service request from a shipper, wherein the freight service request is characterized by load parameters comprising an origin, a destination, a size, and a weight;
generate a compound service offering comprising more than one of the freight service offerings and having service parameters that accommodate the load parameters of the freight service request;
receive, from the shipper, a selected compound service offering that is selected from the compound service offering generated to accommodate the load parameters of the freight service request;
reserve the selected compound service offering; and
dispatch the selected compound service offering.

12. A computer program product according to claim 11 wherein the website portal is further configured to
process a carrier registration of each of the plurality of carriers to access the website portal;
verify the carrier registration of the each of the plurality of carriers upon accessing the website portal; and
restrict each of the plurality of carriers from using the website portal to access confidential carrier information, wherein confidential carrier information comprises the price of the freight service offering of another of the plurality of carriers.

13. A computer program product according to claim 12 wherein the website portal is further configured to
process a shipper registration of the shipper to access the website portal;
verify the registration of the shipper upon accessing the website portal; and
restrict each of the plurality of carriers from using the website portal to access confidential shipper information, wherein the confidential shipper information comprises a name of the shipper.

14. A computer program product according to claim 11 wherein the website portal is further configured to
identify a combination of the lanes of the freight service offerings included in the compound service offering that accommodates the origin and the destination of the freight service request;
identify the respective space of each of the freight service offerings included in the compound service offering that accommodates the size and the weight of the freight service request; and
identify the respective availability of each of the freight service offerings included in the compound service offering is set to indicate that the freight service offering is available for reservation.

15. A computer program product according to claim 11 wherein the website portal is further configured to
generate a consolidated freight service transit time defined as a combination of the transit times of the freight service offerings included in the compound service offering; and
generate a consolidated freight service price defined as a sum of the prices of the freight service offerings included in the compound service offering.

16. A computer program product according to claim 11 wherein the website portal is further configured to set the respective availability of each of the freight service offerings included in the selected compound service offering to indicate that freight service offering is not available for reservation.

17. A computer program product according to claim 15 wherein the website portal is further configured to receive an escrow payment in the form of at least one of a system credit and a credit card payment, wherein the escrow payment is computed as including the consolidated freight service price for the selected compound service offering.

18. A computer program product according to claim 16 wherein the service parameters of each of the plurality of freight service offerings further comprise a status; and wherein the website portal is further configured to
monitoring the status of each of the freight service offerings included in the selected compound service offering, defined as a monitored service offering; and
sending an alert message to at least one of the shipper and the carrier from which the monitored service offering was received, wherein the alert message communicates the status of the monitored service offering.

19. A computer program product according to claim 16 wherein the service parameters of each of the plurality of freight service offerings further comprise a status; and wherein the website portal is further configured to monitor the status of each of the freight service offerings included in the selected compound service offering, defined as a monitored service offering;
identify a freight service offering included in the monitored service offering that has at least one service parameter that does not accommodate the load parameters of the freight service request;
generate an alternative compound service offering comprising more than one of the freight service offerings and having service parameters that accommodate the load parameters of the freight service request;
reserve the alternative compound service offering;
dispatch the alternative compound service offering; and
send an alert message to the carrier from which the monitored service offering was received, wherein the alert message communicates the status of the monitored service offering.

20. A computer program product according to claim 17 wherein the service parameters of each of the plurality of freight service offerings further comprise a status; and wherein the website portal is further configured to
monitor the status of each of the freight service offerings included in the selected compound service offering, defined as a monitored service offering;
identify delivery completion defined as setting the respective status of each of the freight service offerings in the monitored service offering to indicate that the freight service offering in the monitored service offering is complete; and
remit a service payment to the carrier from which the monitored service was received, wherein the service payment is computed as including the price for the monitored service offering and is deducted from the escrow payment.
